(19) United States
(12) Patent Application Publication
(10) Pub. No.: US 2026/0018179 A1
(43) Pub. Date: Jan. 15, 2026

(54) CONTENT AWARE AUDIO PROCESSING

(71) Applicant: Advanced Micro Devices, Inc., Santa Clara, CA (US)

(72) Inventors: Vasuki Soni, Korba (IN); A Srinivas, Hyderabad (IN)

(73) Assignee: Advanced Micro Devices, Inc., Santa Clara, CA (US)

(21) Appl. No.: 18/769,089

(22) Filed: Jul. 10, 2024

(51) Int. Cl. G10L 19/012

(52) U.S. Cl. CPC G10L 19/012

(57) ABSTRACT

Content aware audio processing includes receiving, by a digital signal processor, a frame of audio data. In response to detecting that the frame of audio data is a silent frame, the digital signal processor selects a light graph from a plurality of graphs including the light graph and a full graph. Comfort noise is generated that corresponds to the silent frame. The comfort noise frame is processed through the light graph in place of the silent frame. The light graph is dedicated for processing comfort noise frames.

### TECHNICAL FIELD

This disclosure relates to audio processing and, more particularly, to content aware audio processing.

### BACKGROUND

Processing audio within a computing system is a computationally intensive task. Audio processing may be implemented as an executable audio processing framework that may be specified as a “graph” of connected nodes. Each node corresponds to an application such as a plugin that performs particular audio processing operations. The audio processing framework may vary in complexity based on the particular operating context of the computing system. In some cases, the graph may specify a pipeline formed of a plurality of sequentially ordered nodes. The graph may be more complex and include multiple different branches that operate in parallel and that may be mixed together to generate the audio that is ultimately output.

In a conventional audio processing system, regardless of the complexity of the graph, the audio is processed through the various nodes of the graph regardless of the content of the audio data. That is, all of the audio data is processed through the same graph regardless of whether the audio data includes speech, music, or even silence.

### SUMMARY

In one or more embodiments, a method includes receiving, by a digital signal processor, a frame of audio data. The method includes, receiving, by a digital signal processor, a frame of audio data. The method includes, in response to detecting that the frame of audio data is a silent frame, selecting, by the digital signal processor, a light graph from a plurality of graphs including the light graph and a full graph. The method includes generating a comfort noise frame corresponding to the silent frame. The method includes processing, by the digital signal processor, the comfort noise frame through the light graph in place of the silent frame. The light graph is dedicated for processing comfort noise frames.

In one or more embodiments, a system includes a host processor, a digital signal processor, and a memory coupled to the host processor and to the digital signal processor. The host processor is capable of offloading a frame of audio data from the memory to the digital signal processor. The digital signal processor is capable of, in response to detecting that the frame of audio data is a silent frame, selecting a light graph from a plurality of graphs including the light graph and a full graph. The digital signal processor is capable of generating a comfort noise frame corresponding to the silent frame. The digital signal processor is capable of processing the comfort noise frame through the light graph in place of the silent frame. The light graph is dedicated for processing comfort noise frames.

In one or more embodiments, a digital signal processor includes a central processing unit. The central processing unit is capable of executing operations. The operations include receiving a frame of audio data. The operations include, in response to detecting that the frame of audio data is a silent frame, selecting a light graph from a plurality of graphs including the light graph and a full graph. The operations include generating a comfort noise frame corresponding to the silent frame. The operations include processing the comfort noise frame through the light graph in place of the silent frame. The light graph is dedicated for processing comfort noise frames.

In one or more embodiments, a computer program product includes a computer readable storage medium having program instructions embodied therewith. The program instructions are executable by computer hardware, e.g., a hardware processor such as a digital signal processor, to cause the computer hardware to execute operations as described within this disclosure. The operations include receiving a frame of audio data. The operations include, in response to detecting that the frame of audio data is a silent frame, selecting a light graph from a plurality of graphs including the light graph and a full graph. The operations include generating a comfort noise frame corresponding to the silent frame. The operations include processing the comfort noise frame through the light graph in place of the silent frame. The light graph is dedicated for processing comfort noise frames.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates a system for processing audio in accordance with one or more embodiments of the disclosed technology.

FIG. 2 illustrates a hardware architecture for a digital signal processor as described in connection with FIG. 1 in accordance with one or more embodiments of the disclosed technology.

FIG. 3 illustrates an example of a full graph in accordance with one or more embodiments of the disclosed technology.

FIG. 4 illustrates an example of a light graph in accordance with one or more embodiments of the disclosed technology.

FIGS. 5A and 5B, taken collectively, depict a flow chart illustrating a method of operation of the system of FIG. 1 in accordance with one or more embodiments of the disclosed technology.

FIG. 6 is an example of an audio stream received by the system of FIG. 1 and an audio stream output by the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to audio processing and, more particularly, to content aware audio processing. In accordance with the inventive arrangements described within this disclosure, audio data may be processed in a manner that varies or depends on the content of the audio data. For example, in cases where the audio data includes silence, such portions of audio data may be processed using a graph (e.g., an audio processing framework) that is different from the graph used to process audio data that includes or has audible content.

In one or more embodiments, a hardware processor such as a digital signal processor (DSP) is capable of processing portions of audio data corresponding to silence using a graph, referred to herein as a “light graph.” The DSP processes portions of audio that include audible content (e.g., that do not include or correspond to silence) using a different graph, referred to herein as an “full graph.” The light graph is less complex than the full graph. In this regard, the light graph may be executed in fewer clock cycles than the full graph.

In one or more embodiments, for portions of audio that include silence, the DSP may replace the portions of audio with generated comfort noise. The generated comfort noise may be processed through the light graph in place of the portions of audio data that include silence. The results generated through execution of the light graph may be output, processed further, or used in some other way. In addition, clocking of the DSP may be controlled, e.g., adjusted, dynamically based on whether the audio data being processed includes silence or includes audible content. In other words, the clocking of the DSP may be adjusted dynamically based on which graph is being executed, or executing, at any given time.

The inventive arrangements provide several benefits over conventional audio processing techniques that do not account for content of the audio data. For example, the clocking of the DSP may be reduced at least in part due to the light graph requiring fewer clock cycles for execution than the full graph. By reducing the clock frequency of the DSP, the DSP, and as such the overall system, consumes less power. Further, by processing the generated comfort noise through the light graph in place of the received portion of audio data that included silence, audible artifacts in the audio that is ultimately output may be reduced and/or eliminated. By comparison, processing the portions of audio data that include silence through the light graph may lead to audible artifacts in the audio that is ultimately output.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

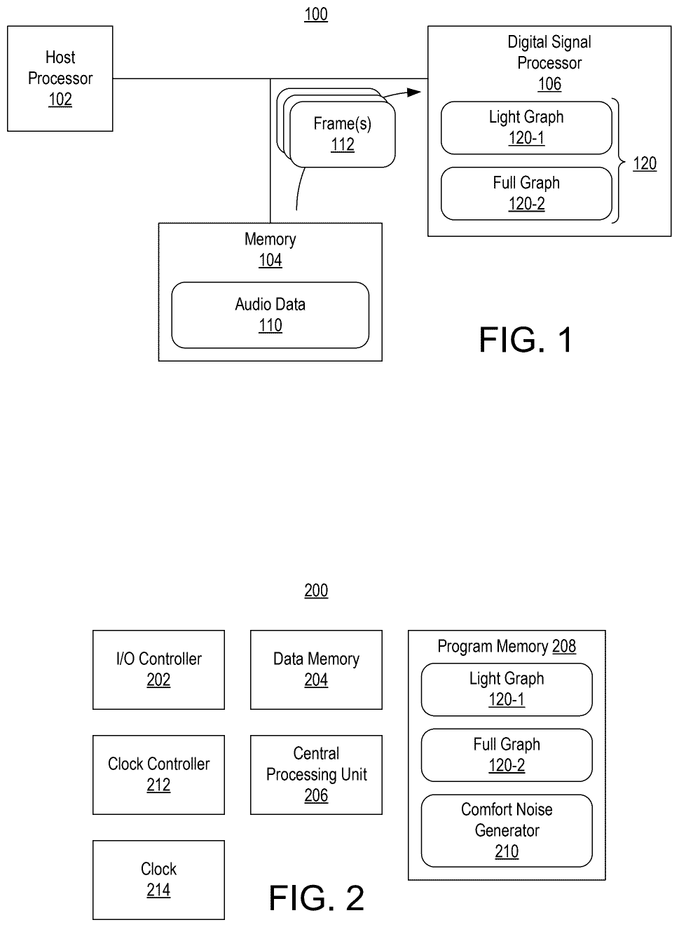

FIG. 1 illustrates a system 100 capable of processing audio in accordance with one or more embodiments of the disclosed technology. System 100 is an example of a data processing system. System 100 includes a host processor 102, a memory 104, and a DSP 106. Host processor 102 and DSP 106 are coupled to memory 104. The components illustrated in FIG. 1 may be coupled by, and communicate over, a communication bus or other type of interconnect circuitry.

In the example, host processor 102 and DSP 106 are implemented as hardware processors. Host processor 102 may be implemented as a central processing unit (CPU). In one or more embodiments, host processor 102, memory 104, and DSP 106 may be implemented as discrete ICs or packages disposed on a circuit board. In one or more other embodiments, host processor 102 and memory 104 may be implemented as separate circuit blocks disposed within a same die of an IC device. In one or more other embodiments, host processor 102 and DSP 106 may be implemented as chiplets disposed in a same package while memory 104 is external to that package. In still other embodiments, host processor 102, memory 104, and DSP 106 may be implemented as chiplets within a same package. Memory 104 may be implemented as any of a variety of volatile memory. For example, memory 104 may be implemented as Double Data Rate, Synchronous Dynamic Random Access Memory (DDR) or as a High-Bandwidth Memory (HBM) stack whether disposed in the same package as one or more of the other ones of the components of FIG. 1 or implemented as a discrete, e.g., separate, component/package.

In the example, memory 104 stores audio data 110. Audio data 110 may be formed of a plurality of audio samples, e.g., digital data. For purposes of illustration and not limitation, audio data 110 may be the audio of a movie, audio of a conversation between people, audio from a documentary, music, or other digitally recorded and/or generated audio. In the example, host processor 102 may place portions of audio data 110 in memory 104 within buffers to be offloaded to DSP 106 for processing.

One technique for handling audio processing in a computing system is referred to as Hardware Offloaded Audio Processing (HAP). This technique processes audio data by offloading audio processing functions from host processor 102 to DSP 106. While FIG. 1 is described as being implemented in a variety of different configurations, in the typical case, audio data is offloaded from the host processor to a standalone DSP that exists outside or external to the host processor (e.g., the main CPU) of the data processing system. The offload process enables DSP 106 to operate on a buffer of audio data in regular intervals without interrupting operation of host processor 102.

The functionality described herein reduces power consumption by system 100 and, as such, any computing device in which system 100 is incorporated. For example, power consumption in devices such as laptops, other portable devices, and/or edge devices such as portable and/or wireless speakers may be reduced. Notwithstanding, the inventive arrangements may be used in any type of device that includes a host processor that offloads audio data to a DSP for processing. The reduction in power consumption may translate directly into extended battery life in the case of portable and/or battery powered devices.

In one or more embodiments, each portion of data may include a number of audio samples representing a particular window of time. For example, each portion of audio data may represent a particular number of milliseconds of audio. A portion of audio data is also referred to herein as a “frame,” where the frame includes a plurality of audio samples.

In offloading audio data, host processor 102 is capable of characterizing frames of audio data 110 in terms of whether each frame includes silence or includes audible content. For purposes of illustration, consider an example of audio data for a movie. Such audio data may include frames of silence that may be interspersed in time with frames of audio data that include audible content. The frames that include silence include zero or negligible audio data, e.g., audio data having a signal level that is below a threshold signal level. This may occur for any of a variety of different reasons such as the audio data being for a conversation with intermittent speaking, e.g., pausing, by the participants, for example.

For purposes of discussion, the determination of whether an audio sample includes silence may be performed by comparing a signal level specified by the audio sample with a predetermined threshold signal level. Those audio samples with a signal level less than or equal to the threshold signal level may be considered to include or specify silence. Those audio samples specifying a signal level above the threshold signal level may be considered to not include silence. An audio sample with a signal level above the threshold signal level may be said to contain audible content.

With respect to a frame of audio data, the frame may be said to include silence based on any of a variety of measures such as each audio sample having a signal level that is less than or equal to the threshold signal level (e.g., less than a threshold decibel (dB) level) or the frame having an average signal level of the audio samples of the frame being less than or equal to the threshold signal level. Similarly, a frame of audio data may be said to include audible content based on any of a variety of measures such as each audio sample having a signal level that is greater than the threshold signal level or an average signal level of the audio samples of the frame of audio data being greater than the threshold signal level.

For purposes of discussion, a frame of audio data that includes silence may also be referred to herein as a “silent frame.” It should be appreciated that a silent frame may include only audio samples specifying absolute silence (e.g., zero signal level), only audio samples with non-zero signal levels that meets the silent frame criteria described, or a mix of audio samples with zero signal level and audio samples with non-zero signal level meeting the silent frame criteria. A frame of audio data that includes audible content may be referred to herein as an “audible frame.”

In the example of FIG. 1, host processor 102 is capable of offloading frames 112 of audio data to DSP 106. In general, the offloading process includes host processor 102 initiating a direct memory access (DMA) operation that delivers one or more frames 112 of audio data to DSP 106 for processing. DSP 106 may implement, e.g., execute, a graph that specifies an audio processing framework. Each graph may be formed of one or more nodes, where each node corresponds to an audio processing function specified as an application, e.g., executable program code. The application(s) may be plugin(s). Connectivity or signal routing among the nodes of the graph is specified by edges connecting the nodes.

In the example of FIG. 1, host processor 102 (e.g., a host process executed by host processor 102) provides, to DSP 106, visibility into a particular window of time of audio data 110. For example, host processor 102 is capable of proactively detecting whether frames of audio data provided to DSP 106 are silent frames or audible frames. This proactive detection is performed prior to host processor 102 providing such frames of audio data to DSP 106. Thus, for a given window of time such as a particular number of seconds or milliseconds (which may include one or more frames), host processor 102 provides audio data that has been characterized or classified as including silence or including audible content to DSP 106.

In cases where a frame of audio data is a silent frame, the audio processing capabilities of DSP 106 are underutilized since the silent frame includes a negligible amount of audio data. Complex signal processing for silent frames of audio data is not necessary. In the example of FIG. 1, DSP 106 includes multiple, e.g., a plurality, of graphs. As illustrated, DSP 106 includes a light graph 120-1 and a full graph 120-2. Light graph 120-1 is dedicated or reserved for processing only comfort noise frames, as described below in greater detail, which are generated in place of silent frames. Full graph 120-2 is dedicated or reserved for processing only audible frames.

In general, DSP 106 may process each frame 112 using a particular graph 120 based on the received frame 112. That is, DSP 106 may process each comfort noise frame generated for a frame 112 of audio data classified as a silent frame with light graph 120-1 and process each frame 112 of audio data classified as an audible frame with full graph 120-2. As different ones of frames 112 may be part of a same stream of audio, DSP 106 is capable of dynamically switching between executing each of graphs 120 as needed based on whether each frame 112 of audio data received is a silent frame or an audible frame. The switching may be performed on a per-frame basis.

At a high level, comfort noise is a low level/amplitude noise simulated using noise features in voice/audio frames. A comfort noise generator refers to circuitry and/or software capable of extracting background noise features in audio frames and using the extracted noise features to simulate background noise in non-active audio frames. For purposes of illustration, and not limitation, comfort noise and the generation thereof is discussed in International Telecommunication Union (ITU)-T G.729 “Series G: Transmission Systems and Media Digital Systems and Networks,” Annex B (2012). The examples provided herein are provided for purposes of illustration and not limitation. Other techniques for generating comfort noise that have or may be developed may be used.

In one or more embodiments, host processor 102 is capable of performing the characterization of frame 112 of audio data. That is, host processor 102 may analyze each frame 112 and detect whether the frame 112 is a silent frame or an audible frame. In this manner, each frame 112 of audio data to be offloaded to DSP 106 may be stored in memory 104 (e.g., as audio data 110) with or including an indication (e.g., a marker, flag, metadata, etc.) specifying whether that frame 112 of audio data is a silent frame or an audible frame. Thus, as each frame 112 is received by DSP 106, DSP 106 is capable of detecting whether the received frame is a silent frame or an audible frame by locating and/or identifying the indication for each such frame 112 as received.

In the example of FIG. 1, the particular hardware processor used to process offloaded audio data is illustrated as a DSP. It should be appreciated that the inventive arrangements may be implemented using any of a variety of hardware processor types whether a DSP, a Graphics Processing Unit (GPU), a CPU, a System-on-Chip (SoC), a Field Programmable Gate Array, an Application-Specific Integrated Circuit (ASIC), a System-in-Package (SiP), an Intelligence Processing Unit, an Inference Processing Unit, a Neural Processing Unit, or the like. As discussed, in some embodiments, the entirety of system 100 may be implemented as a SiP. In general, DSP 106 may be implemented as any of a variety of different types of hardware processors.

In one or more embodiments, system 100 is capable of real-time operation. That is, system 100 is capable of receiving audio data, processing the audio data, and outputting the audio data in real-time.

FIG. 2 illustrates a hardware architecture (e.g., circuitry) 200 for DSP 106 in accordance with one or more embodiments of the disclosed technology. Hardware architecture 200 is provided for purposes of illustration and is not intended to be a limitation of the embodiments described.

In the example, hardware architecture 200 includes an Input/Output (I/O) controller 202. I/O controller 202 may be implemented as a DMA circuit. I/O controller 202 is capable of receiving frames 112 of audio data and storing the frames 112 in data memory 204 for processing. Data memory 204 may be implemented as on-chip, volatile memory. Hardware architecture 200 includes a CPU 206 that is capable of executing computer-readable program code stored in program memory 208. In the example, program memory 208 stores light graph 120-1 and full graph 120-2.

In the examples described within this disclosure, the plurality of graphs is described as including a graph dedicated for processing comfort noise frames and a graph dedicated for processing audible frames. In one or more other embodiments, more than two graphs may be used such that DSP 106 is capable of dynamically switching between executing different ones of the plurality of graphs. In that case, additional comparisons and/or metrics may be included that cause different ones of the graphs to be executed under different circumstance(s) or in response to different condition(s).

Program memory 208 also may include a comfort noise generator 210. Comfort noise generator 210 may be implemented as computer readable program code such as an application or a plugin. In one or more embodiments, comfort noise generator 210 may be implemented as a standalone program capable of communicating with light graph 120-1. In one or more other embodiments, comfort noise generator 210 may be included or implemented as a node within light graph 120-1.

Hardware architecture 200 also may include a clock controller 212. In general, clock controller 212 is capable of controlling the clocking of hardware architecture 200. For example, clock controller 212 is capable of instructing and/or controlling clock 214 to output a clock signal of a particular frequency to the various components illustrated in FIG. 2. In this regard, clock controller 212 is capable of adjusting the clock frequency that is output from clock 214 based on the classification of the frame of audio data being processed.

In one or more embodiments, clock controller 212 is capable of adjusting, e.g., lowering and raising, the clock frequency of hardware architecture 200. As an illustrative and non-limiting example, clock controller 212 is capable of detecting conditions such as data memory 204 storing one or more frames 112 of audio data that are silent frames and storing one or more frames 112 of audio data that are audible frames. Similarly, clock controller 212 may be configured to detect CPU 206 executing light graph 120-1, detect CPU 206 executing full graph 120-2, and/or CPU 206 executing noise generator 210. For example, clock controller 212 is capable of adjusting a clock frequency of DSP 106 based on which graph of the plurality of graphs (e.g., light graph 120-1 or full graph 120-2) is executed or executing (e.g., at any given time).

In one or more embodiments, clock controller 212 is capable of adjusting the clock frequency of hardware architecture 200 from a first clock frequency to a second clock frequency in response to detecting that CPU 206 is processing or has received a frame 112 of audio data that is a silent frame (e.g., executing light graph 120-1). In this example, the second clock frequency is lower than the first clock frequency. Similarly, clock controller 212 is capable of adjusting the clock frequency of hardware architecture 200 from the second clock frequency to the first clock frequency in response to detecting that CPU 206 is processing or has received a frame 112 of audio data that is an audible frame. Appreciably, in cases where CPU 206 processes more than one frame of audio characterized the same way (e.g., as a silent frame or as an audible frame), CPU 206 may continue with the clocking unchanged. In cases where the classification of frames of audio data switch each frame, the clocking may be adjusted on a per-frame basis. In any case, clock controller 212 is capable of dynamically adjusting the clock frequency of hardware architecture 200 based on whether the received frame is a silent frame or an audible frame.

In one or more embodiments, clock controller 212 may execute firmware for DSP 106. Clock controller 212, for example, may detect or be aware of the particular type of graph that is loaded. That is, clock controller 212 is capable of detecting whether light graph 120-1 or full graph 120-2 is loaded into memory for execution. In one aspect, clock controller 212 is capable of detecting the particular graph that is loaded based on detecting which plugins have been loaded into memory for execution and having knowledge of which plugs correspond to which graphs. Clock controller 212 is capable of adjusting clock 214, which may be a main clock of the DSP 106 referred to as the “reference clock.” Adjusting the frequency of the reference clock adjusts the clock frequency of the entire DSP 106.

In one or more embodiments, clock controller 212 is capable of calculating the frequency to which the clock frequency clock 214 may be adjusted based on which of the plugins have been loaded into memory for execution. Each plugin may be profiled in terms of the number of clock cycles required for execution. Accordingly, clock controller 212 is capable of calculating the total number of clock cycles required to execute each graph. With this knowledge, clock controller 212 may adjust the clock frequency of clock 214 so that each graph executes in the same amount of absolute time (or substantially the same amount of absolute time) as measured in fractions of a second though each graph requires a different number of clock cycles to execute.

In another aspect to be described herein in greater detail below, hardware architecture 200 may replace each frame 112 of audio data that includes silence with generated comfort noise. That is, for the window of time represented by a frame 112 of audio data that is a silent frame, CPU 206 may execute comfort noise generator 210 to generate comfort noise. Comfort noise generator 210 may generate any of a variety of different types of noise as generally known using generally available or known noise generation techniques. In one or more embodiments, comfort noise generator 210 may be implemented as a comfort noise generator.

In one or more embodiments, noise generator 210 may receive a silent frame 112 and process the silent frame 112 by replacing each audio sample therein with a synthetically generated audio sample specifying comfort noise resulting in a comfort noise frame. In another example, noise generator 210 may generate a comfort noise frame that replaces silent frame 112. Noise generator 210 may generate a number of comfort noise samples equivalent to the number of audio samples included in the silent frame 112. The comfort noise samples generated, e.g., the comfort noise frame, may be processed through light graph 120-1 in lieu of (e.g., in place of) the original audio samples of silent frame 112. The resulting audio data output from either light graph 120-1 or full graph 120-2 may be stored in data memory 204 and output from hardware architecture 200 via I/O controller 202.

In the example of FIG. 2, both light graph 120-1 and full graph 120-2 are shown in program memory 208. In one or more embodiments, only one graph may be loaded in program memory 208 (e.g., execution memory) to facilitate clock controller 212 being capable of detecting which plugins are loaded into memory for execution. In that case, architecture 200 may include another memory used to store a graph or graphs that are not executed. In still another embodiment, clock controller 212 may determine which graph is executing based on a value of the program counter where particular addresses in program memory 208 store light graph 120-1 and other particular addresses in program memory 208 store full graph 120-2.

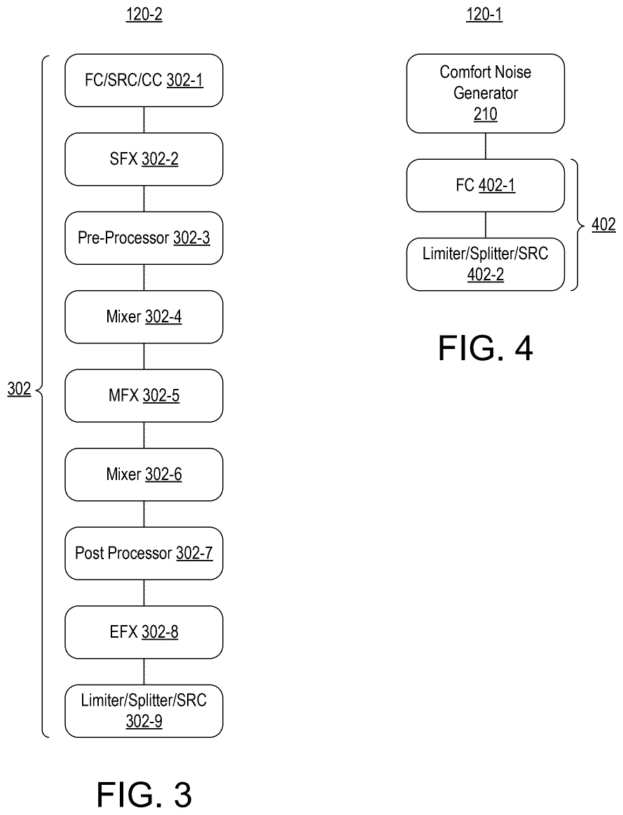

FIG. 3 illustrates an example of a full graph in accordance with one or more embodiments of the disclosed technology. The example full graph of FIG. 3 is capable of, and may be dedicated for, processing audible frames. FIG. 3 may be illustrative of an example implementation of full graph 120-2.

The example of FIG. 3 includes a plurality of nodes 302 (e.g., 302-1, 302-2, 302-3, 302-4, 302-5, 302-6, 302-7, 302-8, and 302-9). Each node 302 is configured to perform one or more audio processing functions, whether applying or performing stream effects (SFX), mode effects (MFX), endpoint effects (EFX), format conversion (FC), source rate conversion (SRC), volume control (VC), peak metering (PM), muting, post processing, limiting, signal splitting, mixing of multiple signals paths or branches (not shown).

Appreciably, each node requires one or more clock cycles to perform. The example of FIG. 3 illustrates a relatively complex audio processing framework or signal processing chain that requires significant clock cycles to execute and process a frame of audio data entirely therethrough.

FIG. 4 illustrates an example of a light graph in accordance with one or more embodiments of the disclosed technology. FIG. 4 may be illustrative of an example implementation of light graph 120-1.

The example of FIG. 4 includes a plurality of nodes 402 (e.g., nodes 402-1 and 402-2). For purposes of illustration, comfort noise generator 210 is shown. Comfort noise generator 210 may be included in light graph 120-1 in some embodiments. In other embodiments, comfort noise generator 210 is distinct and separate from light graph 120-1. In that case, the output generated by comfort noise generator 210 (e.g., a comfort noise frame including generated comfort noise as a plurality of comfort noise samples) may be provided as input to light graph 120-1 in lieu of the original audio samples of the silent frame 112 of audio data.

In the example of FIG. 4, it may be observed that the complexity of light graph 120-1 is significantly less than full graph 120-2. In other words, light graph 120-1 includes fewer nodes than full graph 120-2. For example, a silent frame is similar to a comfort noise frame in that it does not require certain audio processing operations such as filtering or the application of effects (e.g., SFX, MFX, and/or EFX). This means that the number of clock cycles needed to process a comfort noise frame through the entirety of light graph 120-1 is less than the number of clock cycles required to process an audible frame through the entirety of full graph 120-2. In this regard, light graph 120-1 may be considered a graph having reduced latency compared to full graph 120-2 at least in comparisons using same clock frequencies for execution.

In the example, it may be appreciated that the clock cycle savings, e.g., the difference in clock cycles required to process a frame of audio through light graph 120-1 and to process a frame of audio through full graph 120-2 may be used as a metric to determine how much the clocking of DSP 106 may be reduced. For example, in one or more embodiments, the clocking of DSP 106 may be reduced so that, as clocked by the second clock frequency, DSP 106 processes a frame through light graph 120-1 in the same or substantially same amount of absolute time as is required to process a frame through full graph 120-2 at the first clock frequency. The reduction in clock frequency of DSP 106 provides significant reduction in power consumption by DSP 106.

Referring to both FIGS. 3 and 4, the output from the last node in each respective graph may be provided to an audio endpoint such as a speaker, headphones, earbuds, and/or other devices.

It should be appreciated that the graphs illustrated in FIGS. 3 and 4 are provided for purposes of illustration only. Other graphs with different plugin(s), plugin organization and/or hierarchy may be used. Still, full graph 120-1 is characterized in that the number of clock cycles needed to execute the entirety of full graph 120-1 is greater than the number of clock cycles needed to execute light graph 120-1. The processing described, whether by graphs or other computer readable program instructions, may be applied or extended to any type of audio processing pipeline.

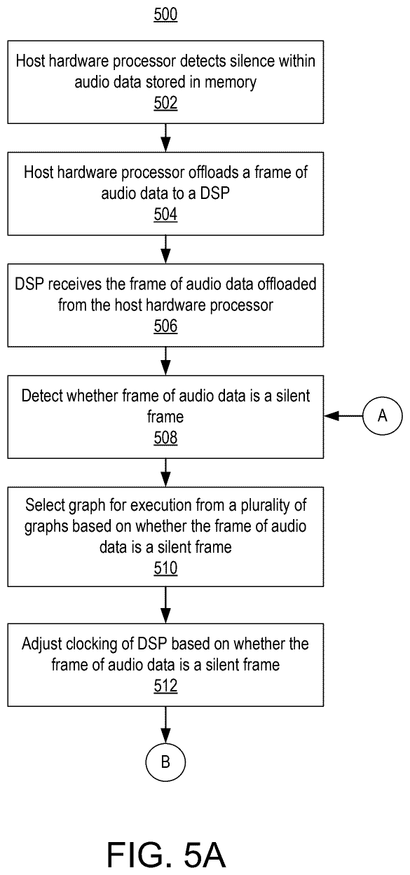

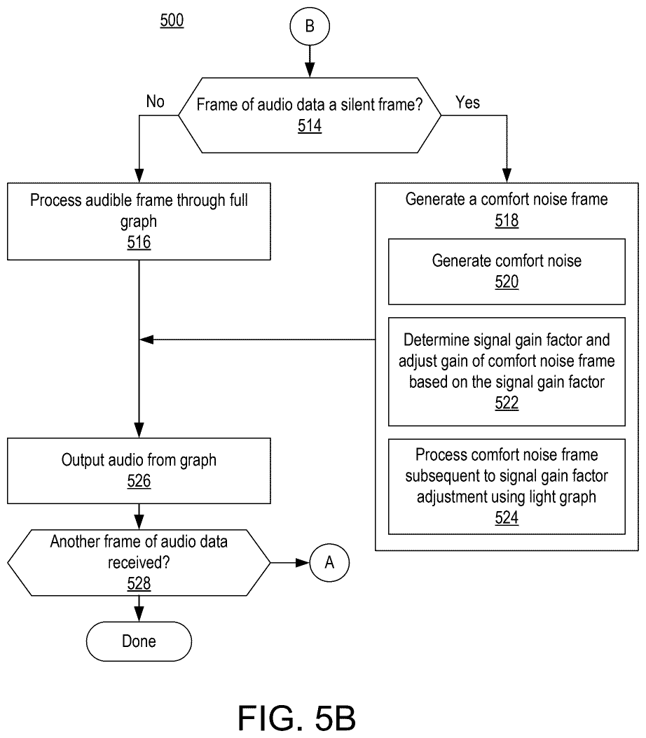

FIGS. 5A and 5B, also collectively referred to herein as FIG. 5, are a flow chart illustrating a method 500 of operation of the system of FIG. 1 in accordance with one or more embodiments of the disclosed technology.

In block 502, host processor 102 detects silence within audio data stored in memory. In one or more embodiments, prior to offloading any audio data to DSP 106, host processor 102 is capable of proactively checking whether the audio data includes silence. In one or more embodiments, the assessment of whether a frame of audio contains silence or audible content as performed by host processor 102 may be performed for a frame of audio data or a plurality of frames of audio data. In one or more embodiments, a frame of audio data may include approximately 5 milliseconds of data. In some examples, host processor 102 is capable of classifying approximately 2 seconds of audio data (e.g., a plurality of frames) for inclusion of silence.

In block 504, host processor 102 offloads one or more frames of audio data to DSP 106. Host processor 102 may offload audio data, e.g., frame(s) thereof, at regular time intervals for processing by DSP 106. This allows DSP 106 to process an amount of data up to the amount offloaded, which may be as much as the amount of audio data that has been classified for inclusion of silence (e.g., 2 seconds or other predetermine time span), without interrupting host processor 102 to request more audio data. In one or more embodiments, host processor 102 is capable of offloading audio data, a frame or frames, to DSP 106 by invoking a DMA operation using a driver of DSP 106. The DMA operation, by execution of the driver of DSP 106, moves one or more frames of audio data to DSP 106.

In block 506, DSP 106 receives a frame of audio data offloaded from host processor 102. As noted, DSP 106 may receive more than one frame for processing at a time. For example, I/O controller 202 receives the frame(s) of audio data and stores the frame(s) of audio data in data memory 204. In block 508, DSP 106 detects whether a frame of audio data, e.g., a current frame to be processed as received from host processor 102, is a silent frame. For example, since the audio data has been characterized by host processor 102 as being a silent frame or an audible frame, DSP 106 may evaluate each frame of audio data for an indicator that indicates whether or not the frame of audio data is a silent frame.

In one or more other embodiments, if the frame is a silent frame, host processor 102 may provide a notification such as a signal indicating that the provided frame is a silent frame to DSP 106. The received signal may be interpreted as an instruction for DSP 106 to implement the processing described herein for a silent frame.

In block 510, DSP 106 (e.g., CPU 206) selects a graph for execution from a plurality of graphs based on whether the frame of audio data is a silent frame. For example, in response to detecting that the frame of audio is a silent frame, DSP 106 selects light graph 120-1 for execution. The light graph 120-1 is a graph that is designated for processing noise frames that are used to replace the silent frames. In response to detecting that the frame of audio includes audible content, e.g., is an audible frame, DSP 106 selects full graph 120-2 for execution. Full graph 120-2 is designated for processing audio data that does not include silence, but rather includes audible content.

In one or more embodiments, in the case where both or multiple graphs are not stored concurrently in program memory 208 (e.g., program execution memory of DSP 106), the selected graph may be loaded into program memory 208 if not already resident. Similarly, a graph not used for processing the current frame may be removed from program memory 208.

In block 512, the clock controller 212 adjusts clocking of DSP 106 based on whether the frame of audio data is a silent frame. For example, in the case where the frame is a silent frame and the current clock frequency is set to a first clock frequency, clock controller 212 adjusts (e.g., decreases) clocking of DSP 106 from the first clock frequency to a second clock frequency. In these examples, the second clock frequency is lower than the first clock frequency. In the case where the frame of audio data is a silent frame and the current clock frequency is set to the second clock frequency, clock controller 212 leaves clocking of the DSP unchanged.

In the case where the frame of audio data is an audible frame and the current clock frequency is set to the first clock frequency, clock controller 212 leaves clocking of the DSP unchanged. In the case where the frame of audio data is an audible frame and the current clock frequency is set to the second clock frequency, clock controller 212 adjusts (e.g., increases) clocking of DSP 106 from the second clock frequency to the first clock frequency. The inventive arrangements provide opportunistic power saving by temporarily lowering the system clock frequency of DSP 106 to save power while processing audio data that contains silence or intermittent silence.

Based on the examples, it should be appreciated that clock controller 212 is capable of adjusting clocking of DSP 106 on a per frame basis and may adjust, or readjust or reset, the clocking of the DSP subsequent to processing each frame. In another example, subsequent to completing execution of light graph 120-1, clock controller 212 may increase the clock frequency from the second clock frequency to the first clock frequency so that any administrative functions or control functions performed by CPU 206 may be performed at the higher clock frequency. Thus, the clocking of DSP 106 may be adjusted subsequent to executing the light graph 120-1 from the second clock frequency to the first clock frequency.

In one or more embodiments, in response to DSP 106 receiving information from host processor 102 that the received frame is a silent frame, DSP 106 may switch to light graph 120-1 and the lower clock frequency. Comfort noise generator 210 may be implemented as low clock intensive program code. For example, comfort noise generator 210 is capable of generating comfort noise in the background concurrently with execution of full graph 120-2 at the higher clock frequency. In that case, comfort noise generator 210 is capable of extracting any reference features needed to generate the comfort noise from the received audio data. In one or more other embodiments, comfort noise generator 210 is capable of generating comfort noise prior to or concurrently with execution of light graph 120-1 at the slower frequency. In that case, in one or more embodiments, host processor 102 may perform reference feature extraction from audio data and provide the reference features to DSP 106 for use by comfort noise generator 210 in generating the comfort noise. Obtaining reference features for generating comfort noise may save DSP 106 processing power to facilitate comfort noise generation at the lower clock frequence.

In block 514, in response to the frame of audio being an audible frame, method 500 continues to block 516. In response to the frame of audio being a silent frame, method 500 continues to block 518.

In block 516, the audible frame is processed through, or using, full graph 120-2. For example, DSP 106, e.g., CPU 206, executes full graph 120-2 and processes the audible frame through full graph 120-2. CPU 206 executes full graph 120-2 at the first, or higher, clock frequency.

In block 518, in the case where the frame of audio data is a silent frame, DSP 106 is capable generating a comfort noise frame. The comfort noise frame, for example, may include only comfort noise samples generated as described herein and none of the original samples of the silent frame. For example, in block 520, through execution of comfort noise generator 210, comfort noise samples are generated. As noted, comfort noise generator 210 is capable of generating comfort noise samples on a one-to-one basis for the samples of the silent frame. For example, the number of comfort noise samples generated and included in the comfort noise frame may be equal to the number of audio samples of the silent frame.

In one or more embodiments, DSP 106 (or host processor 102 as discussed) is capable of extracting the reference noise features continuously from all of the frames of audio data. In response to detecting a silent frame, the most recent reference noise features, e.g., from a predetermined window of time, are used to generate the comfort noise frame to be used in place of the silent frame. Reference noise features may include any of a variety of audio properties commonly used to characterize different types of noise.

In block 522, DSP 106 is capable of calculating a signal gain factor and adjusting the gain of the comfort noise frame based on the signal gain factor. In one or more embodiments, comfort noise generator 210 may be configured to calculate and apply the signal gain factor. In one or more embodiments, DSP 106 is capable of calculating the signal gain factor based on one or more prior frames of audio data using a moving average technique.

For example, DSP 106 is capable of calculating the signal gain factor based on a level of audio data processed prior (e.g., processed and/or played or output immediately prior) to the silent frame. For example, the prior audio data may be the frame that immediately precedes the silent frame in time as the frames are intended to be played or rendered. In one or more embodiments, the signal gain factor is derived based on the dB (decibel) level of audio played just before, e.g., immediately preceding, the silent frame.

As an example, DSP 106 may determine a signal gain factor that, when applied to the comfort noise frame, adjusts the signal gain (e.g., level) of the comfort noise frame to be equal to or substantially similar to the level of the immediately prior frame of audio data that was processed or an average of a predetermined number of prior processed frames. The signal gain factor may increase or decrease the gain of the comfort noise frame based on the level of the prior played audio. DSP 106 adjusts the level of the comfort noise frame based on the signal gain factor. For example, DSP 106 adjusts the levels of the comfort noise samples as generated using the signal gain factor. This process brings the level of the generated comfort noise to match the level of the immediately preceding frame or frames of audio data to prevent users from perceiving a glitch or sudden volume change in the rendered audio that is ultimately played via an output device as the rendered audio transitions from actual audio with audible content to the artificially generated comfort noise.

In block 524, subsequent to any gain adjustments performed, DSP 106 processes the comfort noise frame, in place of the silent frame, using light graph 120-1. Light graph 120-1 is executed by DSP 106 (e.g., CPU 206) at the second, or lower, clock frequency. In performing block 524, the comfort noise frame, post gain adjustment, is processed through light graph 120-1 in place of the silent frame. That is, the comfort noise frame undergoes processing with the resulting output generated from light graph 120-1 replacing what would otherwise have been a processed version of the silent frame within the stream of audio that is ultimately output from system 100. As discussed, light graph 120-1 requires fewer clock cycles to execute than full graph 120-2. In this example, the clock cycles may be longer in duration in view of the adjusted clocking of DSP 106.

Continuing with block 526, the output generated from either the full graph or the silent audio graph, for the current frame of audio data being processed, is output. The resulting audio data may be output to some type of audio output device.

In block 528, DSP 106 detects whether another frame of audio data has been received for processing. In response to detecting that another frame of audio has been received, method 500 loops back to block 508 to continue processing. In response to detecting that another frame of audio has not been received, method 500 may end.

In one or more other embodiments, certain components of DSP 106 also may be powered down or clock gated (e.g., prevented from transitioning or operating by providing such components with a constant or non-transitioning clock signal). For example, while executing the light graph, it may be the case that one or more components (e.g., memories) of DSP 106 are not utilized as the audio processing framework is less computationally intensive and may require fewer hardware resources of DSP 106. In such cases, these components of DSP 106 that are not needed or used for execution of light graph 120-1 may be powered down or clock gated while the clocking of other components of DSP 106 needed to execute light graph 120-1 is reduced. The components may be powered up or have clock gating removed subsequent to completion of execution of the light graph.

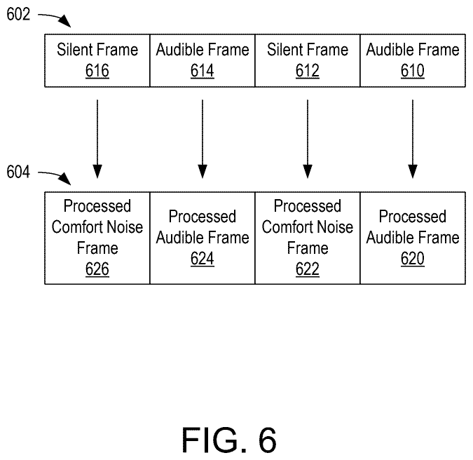

FIG. 6 is an example of an audio stream received by system 100 and an audio stream output by system 100. The example of FIG. 6 is intended as an overview of the audio processing performed by system 100. In the example, audio stream 602 is received by system 100. Audio stream 602 includes audible frame 610, followed by silent frame 612, followed by audible frame 614, followed by silent frame 616. It should be appreciated that silent and audible frames may be received in any order depending on the particular audio content and the ordering shown is for purposes of illustration only.

System 100 generates audio stream 604 from audio stream 602. The vertical arrows indicate the relationship between frames. As output, audio stream 604 includes processed audible frame 620, followed by processed comfort noise frame 622, followed by processed audible frame 624, followed by processed comfort noise frame 626. In the example, system 100 processes audible frame 610 through full graph 120-2 at the first (higher) clock frequency to generate processed audible frame 620. Next system 100 processes silent frame 612 by replacing silent frame 612 with a comfort noise frame. System 100 determines a signal gain factor based on the signal level of audible frame 610 (or a plurality of prior frames) and processes the gain adjusted comfort noise frame through light graph 120-1 at the second (lower) clock frequency to generate processed comfort noise frame 622. Next, system 100 processes audible frame 614 through full graph 120-2 at the first (higher) clock frequency to generate processed audible frame 624. Next system 100 processes silent frame 616 by replacing silent frame 616 with another comfort noise frame. System 100 determines a signal gain factor based on the signal level of audible frame 614 (or a plurality of prior frames) and processes the gain adjusted comfort noise frame through light graph 120-1 at the second (lower) clock frequency to generate processed comfort noise frame 626.

In cases where multiple audio streams are being processed and mixed, the processing described herein for silent frames may be initiated in response to each of the audio streams to be mixed including silence concurrently. For example, in cases where each audio stream to be mixed has a silence frame occurring simultaneously, the system may replace the silence frame of each audio stream with a single comfort noise frame that may be gain adjusted and processed through a light graph operating at a reduced clock frequency. In such cases, multiple parallel processing paths are effectively collapsed to a single pipeline or path which can provide greater reduction in power consumption.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a digital signal processor, a frame of audio data;
in response to detecting that the frame of audio data is a silent frame, selecting, by the digital signal processor, a light graph from a plurality of graphs including the light graph and a full graph;
generating a comfort noise frame corresponding to the silent frame; and
processing, by the digital signal processor, the comfort noise frame through the light graph in place of the silent frame, wherein the light graph is dedicated for processing comfort noise frames.

2. The method of claim 1, further comprising:
adjusting a clock frequency of the digital signal processor based on which graph of the plurality of graphs is executing.

3. The method of claim 2, further comprising:
executing the light graph at a first clock frequency that is lower than a second clock frequency used to execute the full graph.

4. The method of claim 1, wherein the generating the comfort noise frame comprises:
calculating a signal gain factor based on a level of audio data processed prior to the silent frame; and
adjusting a level of the comfort noise frame based on the signal gain factor.

5. The method of claim 1, wherein the frame of audio data includes a plurality of audio samples.

6. The method of claim 1, wherein the frame of audio data is designated to include silence by a host processor configured to offload the frame of audio data.

7. The method of claim 1, wherein the light graph requires fewer clock cycles to execute than the full graph.

8. The method of claim 1, further comprising:
temporarily powering off a memory of the digital signal processor while the light graph executes.

9. A system, comprising:
a host processor;
a digital signal processor; and
a memory coupled to the host processor and to the digital signal processor;
wherein the host processor is capable of offloading a frame of audio data from the memory to the digital signal processor;
wherein the digital signal processor is capable of:
in response to detecting that the frame of audio data is a silent frame, selecting a light graph from a plurality of graphs including the light graph and a full graph;
generating a comfort noise frame corresponding to the silent frame; and
processing the comfort noise frame through the light graph in place of the silent frame, wherein the light graph is dedicated for processing comfort noise frames.

10. The system of claim 9, wherein the digital signal processor includes a clock controller configured to adjust a clock frequency of the digital signal processor based on which graph of the plurality of graphs is executing.

11. The system of claim 10, wherein the clock controller is configured to adjust the clock frequency of the digital signal processor from a first clock frequency to a second clock frequency, wherein the second clock frequency is lower than the first clock frequency, and wherein the light graph is executed at the second clock frequency.

12. The system of claim 11, wherein the clock controller is configured to adjust clocking of the digital signal processor subsequent to the executing the light graph from the second clock frequency to the first clock frequency.

13. The system of claim 9, wherein the generating the comfort noise frame comprises:
calculating a signal gain factor based on a level of audio data processed prior to the silent frame; and
adjusting a level of the comfort noise frame based on the signal gain factor.

14. The system of claim 9, wherein the frame of audio data is a frame including a plurality of audio samples.

15. The system of claim 9, wherein the frame of audio data is designated by the host processor to include silence.

16. The system of claim 9, wherein the light graph requires fewer clock cycles to execute than the full graph.

17. The system of claim 9, further comprising:
a further memory;
wherein the further memory is temporarily powered off while the light graph executes.

18. A digital signal processor, comprising:
a central processing unit capable of executing operations including:
receiving a frame of audio data;
in response to detecting that the frame of audio data is a silent frame, selecting a light graph from a plurality of graphs including the light graph and a full graph;
generating a comfort noise frame corresponding to the silent frame; and
processing the comfort noise frame through the light graph in place of the silent frame, wherein the light graph is dedicated for processing comfort noise frames.

19. The digital signal processor of claim 18, further comprising:
a clock controller circuit capable of adjusting a clock frequency of the digital signal processor based on which graph of the plurality of graphs is executing.

20. The digital signal processor of claim 18, wherein the central processing unit is capable of executing operations comprising:
calculating a signal gain factor based on a level of audio data processed prior to receiving the silent frame; and
adjusting a level of the comfort noise frame based on the signal gain factor.
